(19) United States
(12) Patent Application Publication
(10) Pub. No.: US 2005/0235974 A1
(43) Pub. Date: Oct. 27, 2005

(54) Air fuel ratio control apparatus for engines

(75) Inventors: Takumi Nonaka, Iwate-ken (JP); Mitsuhiro Iwaana, Iwate-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Zama Japan Co., Ltd., Iwate-Ken (JP)

(21) Appl. No.: 11/111,784

(22) Filed: Apr. 22, 2005

(30) Foreign Application Priority Data
Apr. 22, 2004 (JP) 2004-126314
Oct. 20, 2004 (JP) 2004-305762

(51) Int. Cl. F02D 41/14

(52) U.S. Cl. 123/672

(57) ABSTRACT

An air fuel ratio control apparatus readily satisfies an emission requirement and is particularly preferable for small-displacement engines. The air fuel ratio control apparatus for an engine includes a fuel control member disposed in a fuel passage delivering fuel from a fuel metering chamber of a carburetor supplying the fuel to a suction passage of a comparatively small engine such as a general purpose engine, a working machine engine and the like, a combustion gas sensor disposed in an exhaust pipe in the engine, and an electronic control unit. The control unit actuates the fuel control member in response to a concentration of a combustion gas component in an exhaust gas detected by the combustion gas sensor so as to control a fuel flow rate.

### BACKGROUND OF THE INVENTION

1. Field of the Invention

The present invention relates to air fuel ratio control apparatus, which may be readily applied to satisfy an emission requirement and may be applied to engines or the like, which are used as a power source of a working machine. The apparatus of the present invention is especially suited for use with comparatively compact engines, which have little or no extra space for attaching such apparatus, unlike engines for passenger vehicles, such as a general purpose engine, a compact, general purpose engine; a portable, working machine engine; a lawn mower engine; and the like.

2. Description of Related Art

In order to reduce a harmful component contained in the exhaust gas of an engine so as to satisfy an emission requirement, air fuel ratio control apparatus has been used, which detects an amount of oxygen contained in the exhaust gas by using an oxygen sensor (hereinafter an “O₂ sensor”), controls a fuel flow rate so as to establish a theoretical air fuel ratio in correspondence with a concentration of oxygen in the exhaust gas, and changes the harmful component to a harmless component at a high conversion rate by using a three-way catalyst.

Nevertheless, known air fuel ratio control apparatus, as described above, require an electronic control unit having a considerable computational and control capacity in addition to the O₂ sensor and the three-way catalyst. Because of these additional capacities, the apparatus increases greatly in size, complexity, weight, and cost. Accordingly, it is difficult to connect this apparatus to all engines, for example, a general purpose engine which requires a compact size, a reduced weight, and an easy handling properties, such as in portable, working machines or the like.

In response to these requirements, a structure is described in the specification of U.S. Pat. No. 5,709,193, in which an electric motor driven, adjusting needle valve and an electromagnetically driven, opening and closing valve, as occasion demands, are provided in a fuel passage delivering fuel from a fuel metering chamber of a carburetor supplying the fuel to a suction passage of a two-cycle engine. An electronic control unit actuates the adjusting needle valve and the opening and closing valve in correspondence with changes in engine speed, thereby controlling an air fuel ratio in the lean region of an air-fuel mixture. Because this structure may control the fuel flow rate so as to control the air fuel ratio without using an O₂ sensor, this structure may be made compact and may be applied to general purpose engines or the like. Nevertheless, because this structure does not take into direct consideration the detection of an actual state of the exhaust gas so as to satisfy emission requirements, this structure is not a complete solution to the presented problem.

### SUMMARY OF THE INVENTION

A need has arisen for an air fuel ratio, control system for use with the air fuel ratio control of general purpose engines, which is suitable in view of the size, the weight, the cost, and similar limitations described above. The technique described above for controlling the air fuel ratio by using engine speed does not take into consideration the need also to satisfy the emission requirements, yet to maintain a simple structure. Thus, it is a technical advantage of the present invention that it provides an air fuel ratio control apparatus which readily satisfies the emission requirements and is particularly preferable for an engine having a small displacement.

In order to achieve the technical advantage described above, in accordance with the present invention, an air fuel ratio control apparatus of an engine comprises a fuel control member placed in a fuel passage delivering fuel from a fuel metering chamber of a carburetor supplying the fuel to a suction passage of a comparatively small engine, such as a general purpose engine, a working machine engine, and the like; a combustion gas sensor placed in communication with an engine exhaust, e.g., in an exhaust pipe, of the engine; and an electronic control unit, wherein the control unit actuates the fuel control member in response to a concentration of a combustion gas component in an exhaust gas detected by the combustion gas sensor so as to control a fuel flow rate.

A precise air fuel ratio control is not always necessary in order for the general purpose engine to satisfy the emission requirements, and if the concentration of the harmful component is within a numeric range of the emission requirements, the emission requirements may be satisfied. The present invention is structured to detect a concentration of an optional specific component, e.g., carbon monoxide (hereinafter “CO”), in the combustion gas. CO is identified as a harmful component when contained in the exhaust gas and may be detected by using the combustion gas sensor which is inexpensive in comparison with the O₂ sensor. The control unit actuates the fuel control member so as to dilute the air-fuel mixture in order to lower the concentration of CO, thereby controlling the fuel flow rate. Accordingly, it is possible to control the air fuel ratio so as to satisfy the emission requirements without using the known and relatively expensive O₂ sensor and the three-way catalyst and by using the large capacity of control unit.

In this case, as the combustion gas is detected and diluted in the present invention, the harmful component may be carbon monoxide, hydrogen, carbon hydride, sulfur dioxide, nitrogen dioxide, or the like.

Further, in accordance with the present invention, the air fuel ratio control apparatus may be used in a forcibly air-cooled engine in which an engine is provided with a cooling fan, comprising: a fuel control member disposed in a fuel passage delivering fuel from a fuel metering chamber of a carburetor and supplying fuel to a suction passage of the general purpose engine; an air delivery path introducing a portion of a discharged air for the cooling fan to an exhaust pipe of the general purpose engine; a combustion gas sensor disposed in a downstream side of an air delivery path connection position in an exhaust pipe; and an electronic control unit, wherein the control unit actuates the fuel control member in correspondence with a concentration of a combustion gas component in an exhaust gas detected by the combustion gas sensor so as to control a fuel flow rate.

Many combustion gas sensors have a low concentration range for detecting gas concentration and are inferior in a heat resisting properties. The present invention lowers the concentration of the harmful component to a detectable range by mixing a portion of the air for air cooling to the exhaust gas, and widens a usable range of choice of the combustion gas sensor by lowering an exhaust gas temperature to a usable temperature range.

Further, in order to achieve the technical advantages of the present invention, it is preferable that a CO sensor is used as the combustion gas sensor, and an electromagnetic valve is used as the fuel control member. It is known that of the harmful components in the exhaust gas, CO is contained at the largest quantity and may attain a maximum concentration of about 10% in a high concentration region of the air-fuel mixture without relation to a size or output of the engine, and becomes about 1% in a lean region at a position near the theoretical air fuel ratio. Accordingly, it is effective for achieving the desired technical advantage of the invention to detect the concentration of CO in the exhaust gas by using the CO sensor and to close the opening and closing valve so as to reduce the concentration of CO to satisfy an emission requirement compliance range. Further, if a normally open-type electromagnetic valve is used as the electromagnetic valve, the fuel passage is left open at a time when the valve is not operated due to a disconnection or the like. Accordingly, it is possible to maintain a normal function as the carburetor so as to continue an engine operation.

In accordance with the present invention, it is possible to readily and securely control the air fuel ratio so as to satisfy the emission requirement in the engine serving as the power source particularly employed in the comparatively compact machine without making a whole structure large in size, heavy in weight, and expensive.

Further objects, features, and advantages of the present invention will be understood from the following detailed description of preferred embodiments of the present invention with reference to the accompanying figures.

### BRIEF DESCRIPTION OF THE DRAWINGS

Embodiments of the invention now are described with reference to the accompanying figure, which is given by way of example only, and is not intended to limit the present invention.

FIG. 1 depicts a schematic diagram showing an embodiment in accordance with the present invention.

### DETAILED DESCRIPTION OF PREFERRED EMBODIMENTS

A description is given of an embodiment in accordance with the present invention with reference to the accompanying figure.

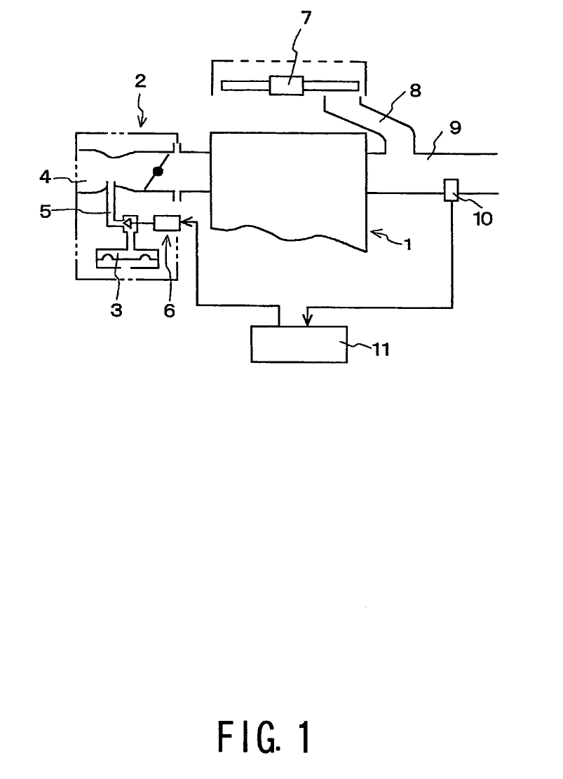

FIG. 1 depicts a schematic diagram of an embodiment of the present invention in which the apparatus is applied to an engine 1 using a diaphragm-type carburetor corresponding to a carburetor 2 for supplying a fuel. A fuel control member 6, for example, comprising an opening and closing valve is disposed in a fuel passage 5 for delivering the fuel from a fuel metering chamber 3 to a suction passage 4.

In the present embodiment, engine 1 comprises a forcibly air-cooled engine and is provided with a cooling fan 7. Engine 1 is structured, such that a portion of a discharged air of cooling fan 7 is introduced into an exhaust pipe 9 of engine 1 by an air delivery path 8. Further, a combustion gas sensor 10, e.g., a CO sensor, detecting a concentration of a combustion gas, e.g., a CO gas, component in the exhaust gas is disposed in a downstream side of a connection portion of air delivery path 8 of exhaust pipe 9.

In addition, an electronic control unit 11 is provided, and control unit 11 is structured so as to send a control signal to fuel control member 6 corresponding to the concentration of the combustion gas detected by combustion gas sensor 10.

Fuel control member 6 may be structured, such that a valve body is moved forward and backward by an electric motor. Nevertheless, fuel control member 6 in which the valve body is moved forward and backward by an electromagnet also is extremely responsive. In particular, a normally open-type electromagnetic valve is preferable because the normally open-type electromagnetic valve is fixed in a valve open position at a time when a malfunction such as the disconnection of the electric system occurring. Despite such a disconnection or other malfunction, however, fuel passage 5 remains open, thereby allowing the carburetor 2 to maintain a normal function.

Combustion gas sensor 10 may be used by selecting an appropriate structure from a combustion contact-type sensor which measures a temperature change of a hot wire due to its contact with the combustion gas; a galvanic cell-type which measures an electrolytic current caused by an electrolysis of gas; a semiconductor-type which measures a change of electric conductivity caused by gas adsorption on a metal oxide semiconductor surface, and the like. In this embodiment, it is preferable that the CO sensor is used as combustion gas sensor 10, and that the air fuel ratio control is executed, such that the CO concentration remains at a maximum of about 10% of the exhaust gas and is within the emission requirements compliance range.

The present embodiment having the structure described above is configured, such that the combustion gas regarded as the harmful component in the exhaust gas generated by the operation of engine 1 is detected by combustion gas sensor 10. The detected concentration of the combustion gas is input to control unit 11, so that it may be determined whether or not the concentration is more than the emission requirements value. Further, if the concentration is more than the emission requirements value, control unit 11 transmits the valve closing signal to fuel control member 6 in such a manner as to close fuel passage 5 for a time set in accordance with the concentration of the combustion gas so as to temporarily shut off the fuel supply. The valve closing is executed only for a relatively short time so as to prevent engine malfunction from being caused by the fuel shortage, thereby reducing the fuel flow rate. As a result, the air-fuel mixture becomes lean, and the concentration of the combustion gas is lowered. In this embodiment, when the valve closing a single time does not satisfy the emission requirements, the valve closing is repeated until compliance with the emission requirements is achieved. In this embodiment, it is preferable to repeat the valve closing for a relatively short time at a certain interval in such a manner as to prevent engine operation from being unnecessarily obstructed, and to shorten the valve closing time in accordance with the reduction of the concentration of the combustion gas so as to satisfy the emission requirement compliance range.

In this embodiment, combustion gas sensor 10 may be readily acquired from among the sensors available in the market, for example, a CO sensor or the like. Nevertheless, when, the concentration of the combustion gas is detected by the sensor having a high sensibility for a low gas concentration, for example, a semiconductor-type gas sensor, or when the combustion gas sensor is improper for use under a high temperature, it is possible to adapt on the basis of the present embodiment, whereby the exhaust gas is diluted by introducing a portion of the discharged air of cooling fan 7 to exhaust pipe 9 by air delivery path 8 and to thereby lower the exhaust gas temperature. Because cooling fan 7 is driven by the engine, the amount of the discharged air is approximately in proportion to the amount of the exhaust gas. Accordingly, it is possible to precisely execute the fuel flow rate control without making the unstable or inaccurate detection of the concentration of the combustion gas obtained by diluting the exhaust gas in an approximately constant manner.

As may be understood from the foregoing description, in accordance with the present embodiment, the concentration of the combustion gas in exhaust gas of engine 1 may be set within the emission requirements compliance region by using specific combustion gas sensor 10. For example, the CO sensor is readily acquired and is inexpensive in comparison with the O₂ sensor, and a program of sending the control signal to fuel control member 6 may be established in correspondence with the specific concentration of the combustion gas in the exhaust gas and controlling the fuel flow rate so as to temporarily close fuel passage 5 and lower the specific concentration of the combustion gas, in control unit 11. Further, because large sized and heavy weighted parts are not added, the apparatus may be tailored to small-displacement, general purpose engines which are loaded on portable working machines without making the whole structure large in size, complex, heavy, or expensive, contrary to the passenger vehicle engine, thereby preserving the usability of such small displacement general purpose engines.

In the present embodiment, the invention is applied to the diaphragm-type carburetor serving as the carburetor supplying the fuel. Nevertheless, the present invention may be applied to the other types of carburetor, such as a float-type carburetor or the like, and the fuel control member is not limited to the opening and closing valve, but may employ an electric motor-driven regulating needle valve provided in the fuel passage for delivering the fuel from the fuel metering chamber of the carburetor and supplying the fuel to the suction passage.

Further, the present invention is structured, such that the fuel is controlled by the fuel control member provided in the fuel passage delivering fuel from the fuel metering chamber of the carburetor and supplying the fuel to the suction passage. This function may be accomplished without being limited to an engine type, such as a 2-cycle engine, a 4-cycle engine, or the like.

Although embodiments of the present invention have been described in detail herein, the scope of the invention is not limited thereto. It will be appreciated by those skilled in the art that various modifications may be made without departing from the scope of the invention. Accordingly, the embodiments disclosed herein are only exemplary. It is to be understood that the scope of the invention is not to be limited thereby, but is to be determined by the claims which follow.

1. An air fuel ratio control apparatus of an engine comprising:
a fuel control member disposed in a fuel passage delivering fuel from a fuel metering chamber of a carburetor supplying the fuel to a comparatively small engine such;
a combustion gas sensor disposed in communication with an engine exhaust as to detect an exhaust gas in said engine; and
an electronic control unit,
wherein said control unit actuates said fuel control member in response to a concentration of a combustion gas component in an exhaust gas detected by said combustion gas sensor so as to control a fuel flow rate.

2. An air fuel ratio control apparatus as claimed in claim 1, wherein said combustion gas sensor comprises a CO sensor.

3. An air fuel ratio control apparatus as claimed in claim 1, wherein said fuel control member comprises an electromagnetic valve which is normally open.

4. An air fuel ratio control apparatus as claimed in claim 3, wherein said combustion gas sensor comprises a CO sensor.

5. An air fuel ratio control apparatus as claimed in claim 1, wherein said combustion gas sensor comprises a combustion contact-type sensor.

6. An air fuel ratio control apparatus as claimed in claim 5, wherein said fuel control member comprises an electromagnetic valve which is normally open.

7. An air fuel ratio control apparatus as claimed in claim 6, wherein said combustion gas sensor comprises a CO sensor.

8. An air fuel ratio control apparatus as claimed in claim 5, wherein said combustion gas sensor comprises a CO sensor.

9. An air fuel ratio control apparatus as claimed in claim 1, wherein said control unit controls the fuel flow rate by operating the fuel control member so as to maintain the concentration of the combustion gas in the exhaust gas detected by the combustion gas sensor within a predetermined range.

10. An air fuel ratio control apparatus as claimed in claim 9, wherein said combustion gas sensor comprises a combustion contact-type sensor.

11. An air fuel ratio control apparatus as claimed in claim 9, wherein said fuel control member comprises an electromagnetic valve which is normally open.

12. An air fuel ratio control apparatus as claimed in claim 11, wherein said combustion gas sensor comprises a CO sensor.

13. An air fuel ratio control apparatus as claimed in claim 9, wherein said combustion gas sensor comprises a CO sensor.

14. An air fuel ratio control apparatus of an engine comprising:
a fuel control member disposed in a fuel passage delivering a fuel from a fuel metering chamber of a carburetor supplying the fuel to a suction passage of the engine;
an air delivery path introducing a portion of a discharged air from a cooling fan provided in the engine or from an independently provided blast fan to an exhaust pipe of said engine;
a combustion gas sensor disposed in a downstream side of an air delivery path connection position in said exhaust pipe; and
an electronic control unit,
wherein said control unit actuates said fuel control member in correspondence to a concentration of a combustion gas component in an exhaust gas detected by said combustion gas sensor so as to control a fuel flow rate.

15. An air fuel ratio control apparatus as claimed in claim 14, wherein said combustion gas sensor comprises a CO sensor.

16. An air fuel ratio control apparatus as claimed in claim 14, wherein said fuel control member comprises an electromagnetic valve which is normally open.

17. An air fuel ratio control apparatus as claimed in claim 16, wherein said combustion gas sensor comprises a CO sensor.

18. An air fuel ratio control apparatus as claimed in claim 14, wherein said combustion gas sensor comprises a combustion contact-type sensor.

19. An air fuel ratio control apparatus as claimed in claim 18, wherein said fuel control member comprises an electromagnetic valve which is normally open.

20. An air fuel ratio control apparatus as claimed in claim 19, wherein said combustion gas sensor comprises a CO sensor.

21. An air fuel ratio control apparatus as claimed in claim 18, wherein said combustion gas sensor comprises a CO sensor.

22. An air fuel ratio control apparatus as claimed in claim 14, wherein said control unit controls the fuel flow rate by operating the fuel control member so as to maintain the concentration of the combustion gas in the exhaust gas detected by the combustion gas sensor within a predetermined range.

23. An air fuel ratio control apparatus as claimed in claim 22, wherein said combustion gas sensor comprises a combustion contact-type sensor.

24. An air fuel ratio control apparatus as claimed in claim 22, wherein said fuel control member comprises an electromagnetic valve which is normally open.

25. An air fuel ratio control apparatus as claimed in claim 24, wherein said combustion gas sensor comprises a CO sensor.

26. An air fuel ratio control apparatus as claimed in claim 22, wherein said combustion gas sensor comprises a CO sensor.
